(19) United States
(12) Patent Application Publication
(10) Pub. No.: US 2009/0047928 A1
(43) Pub. Date: Feb. 19, 2009

(54) Method and system for using message based security challenge and response questions for multi-factor authentication in mobile access to electronic information

(76) Inventors: Thomas F. Utsch, Allentown, PA (US); Griff L. Griffith, Las Vegas, CA (US)

Correspondence Address: Thomas Utsch, Apt 3, 1142 Manhattan Avenue, Hermosa Beach, CA, 90254, US

(21) Appl. No.: 12/215,955

(22) Filed: Jun. 30, 2008

Related U.S. Application Data
(60) Provisional application No. 60/958,262, filed on Jul. 3, 2007.

(51) Int. Cl. H04M 1/66

(52) U.S. Cl. 455/410

(57) ABSTRACT

A method for allowing an alleged user to establish using multiple factors of authentication that he or she is in fact the authorized user of an information source. The method uses multiple factor authentication using challenge and response messages containing personal choices of the user which are not known to people other than the authorized user, presenting the challenge questions as enumerated multiple choice questions for ease of use, and imposing time-out restrictions on a session.

### CROSS REFERENCE TO RELATED APPLICATIONS

This application claims the benefit of U.S. Provisional Application 60/958,262 filed Jul. 3, 2007 and entitled “Eeminder Message Based Multifactor Authentication”, which application is incorporated herein by reference.

### FIELD OF THE INVENTION

The present invention relates to a system and method for using electronic messaging, e.g., email messaging, SMS text messaging, or Instant Messaging to authenticate that a user who is attempting to access an information source is in fact the person who he/she claims to be, such as a consumer, customer, or employee, in attempting to access the information source. The invention also provides the ability to authenticate a user prior to receive, update, and insert information to and from a datasource using any messaging client, whether mobile device or desktop device in origin.

### BACKGROUND OF THE INVENTION

Wireless technologies have exploded over the past few years allowing a person to have real time access to all of his/her email from a small handheld device that also serves as a mobile telephone.

But while the usefulness of ubiquitous access to email is very high, the opportunity for access is also vulnerable to surreptitious or unauthorized access. Verifying that the cell phone number from which a text message originates or the email address from which an email message originates matches that of the supposed user is not sufficient. Messaging systems, which can only authenticate based on the address of the user (email address, cell phone address, instant messaging address), and are inherently subject to spoofing and other surreptitious means of an unauthorized user pretending to be sending messages from the address of an authorized user. The invention described herein provides additional factors of authentication which prevent the unauthorized user from surreptitiously gaining access. Taken together with other known identifiers, the invention establishes beyond reasonable doubt that the alleged user is in fact the actual user attempting to gain access and information.

Further, security in accessing corporate or enterprise systems via a mobile device is not a trivial problem to solve and hence many large organizations deny access to mobile connections due to fear of corporate espionage or attacks such as trojan horse attacks.

The Federal Financial Institutions Examination Council (FFIEC) has published guidelines for financial on-line services in 2005 which mandate that a number of independent factors, commonly called multi-factor authentication, matching the user attempting to gain access to stored attributes of this user be shown to be correct before access to the information source can be established.

### SUMMARY OF THE INVENTION

The present invention is directed to a method and system of using electronic messaging to authenticate with multiple factors users attempting to interact with a datasource using multiple choice challenge and response questions.

Generally speaking, exemplary embodiments of the present invention enable users with a generic or standard messaging client (either email, SMS messaging, or Instant Messaging) to send and receive messages to and from a datasource or database server. The messages received and sent as replies include content of multiple choice questions containing personal preferences or other not widely known information about the user. By replying with the correct multiple choice response, either as an integer or alphanumeric character corresponding to that choice, or to successive challenge and response questions with the correct choice, together with the knowledge of other unique identifiers, for example in one embodiment that the messages are being sent to and received from a unique cell phone number or email address corresponding to the user, and also taken together with some pre-established time period (commonly called a timeout period by someone who is versed in the art), establish to the degree required by common security and authentication standards that the user is in fact the user whose information is attempted to be accessed. The single default factor in the authentication of a cell phone used for messaging is the phone number. If the user's phone number is registered as part of his/her profile by the information source, then receipt of a message from that phone number or phone's unique email address constitutes one factor of authentication. The present invention extends this single factor to a potentially unlimited number of factors, depending on the preferences of the owner of the information source. The second factor of authentication is the reply to a message sent from the information source to the cell phone. When the user replies to this message, the information source gets another factor of verification that it is in fact communicating with the cell phone owned by the user. The third factor of authentication is the user's reply to a randomly selected multiple choice challenge question sent as a message from the information source to the user's cell phone. The question could be for example “what is your favorite color” and the choices are presented as “1-blue 2-red 3-green 4-pink 5-magenta”. The user only needs to send a reply message with the integer corresponding to his/her choice in the body of the message, increasing ease of use by limiting typing by the user to one keystroke. The enumerrated choices are randomly ordered by the system for each use of the challenge question. The fourth (through whatever level of factors a particular embodiment requires) operate on the same design as the third factor described above. They are randomly chosen by the system during each user session and the choices for each are randomly ordered in each challenge question message. Multiple choice questions include but are not limited to what is your favorite color, what is your favorite food, what is the first name of your best friend, what is your favorite city, what is your favorite sports team, what is your favorite movie or TV show, what is the name of your favorite animal, what is the first name of your favorite teacher, what is the name of your favorite hero or someone that you look up to, what is the name of your favorite restaurant. In executing the present invention, the system uses the following logical process in one embodiment of the invention. Possible answers to the picked challenge questions are picked randomly from the complete list of possible answers corresponding with the picked challenge question. All of the answers are displayed as lower case with the first letter of each word capitalized. After this, the real answer, as picked by the end-user, is compared to all 5 of the possible answers for a match. If there is no match, then one of the 5 possible answers is substituted with the real answer. Afterwards the 4 possible answers with the real answer, to the picked challenge question, are randomly sorted, with the number 1 assigned to the now first answer, number 2 to the second, and so on; for display to the end-user. The end-user simply needs to reply the number 1 to 5 to answer the challenge question. Although it is possible to guess 1 out of 5 (20% chance), combining this strategy with the remaining security authentication factors makes the entire process impossible simply by guessing one challenge question.

According to an exemplary embodiment, a method that authenticates a user using message-based challenge and response questions generally includes establishing an address to which an initial request email message can be sent. This address can be an email address, cell phone number, or instant messaging address, among other options. This message contains a question relating to personal information about the alleged user which someone other than the actual user would not know. The message may present the choices for response as mulitple choice answers, each enumerated with an integer or other unique alphanumeric character. To reply to the message, the user sends a reply message with content of either the correct enumerated response (for ease of use as there is only one character to type in that case) or the complete answer. If the reply contains the correct answer, one step in the authentication process has been satisfied. Another challenge and response question may optionally be sent containing different personal information about the alleged user. The enumeration of the response options for this second question reset so that the first answer corresponds to the first digit or alphanumeric character in the sequence of enumeration and the same enumeration choices are re-used on each successive challenge question. Due to the fleeting connectivity with messaging devices, after a pre-established time period has passed without a response from the user or other activity, the session is timed out, i.e. ended. A new challenge and response sequence begins when the user attempts to access the system again. At all times the questions being sent to the alleged user are randomized so that the same questions do not get sent over and over. Also all of the response options in the message, which consists of one correct choice and many incorrect but similar choices, are randomized in order.

Other objects and features of the present invention will become apparent from the following detailed description, considered in conjunction with the accompanying system schematics and flow diagrams. It is understood, however, that the drawings, which are not to scale, are designed solely for the purpose of illustration and not as a definition of the limits of the invention, for which reference should be made to the appended claims.

### BRIEF DESCRIPTION OF THE DRAWINGS

FIG. 1 is an overview of the system architecture in accordance with an exemplary embodiment of the present invention.

FIG. 2 is an exemplary embodiment of an email message body with a multiple choice challenge question with enumerated response options.

FIG. 3 is continuation of the exemplary embodiment of the email message in FIG. 2.

FIG. 4 is an exemplary embodiment of a timeout challenge question to re-authenticate the user.

FIG. 5 is a continuation of the exemplary embodiment of the email message in FIG. 4.

FIG. 6 is an exemplary diagram of a reply to answer an enumerated challenge question by replying with only the enumerated identifier of the chosen response.

FIG. 7 is an exemplary embodiment of a database structure to track the enumerated correct choice being sent to each user since both the questions and the order of possible answers are always randomized.

### DETAILED DESCRIPTION

The following is a description of example embodiments of the invention, which are further described by the included drawings. The embodiments are examples and are in such detail as to clearly communicate the invention. However the amount of detail offered is not intended to limit the anticipated variations of embodiments; on the contrary, the intention is to cover all modifications, equivalents, and alternatives falling within the spirit and scope of the present invention as defined by the appended claims. The descriptions and drawings below are designed to make such embodiments obvious to a person of ordinary skill in the art.

Whether properly viewed as devices, methods, or systems, the disclosed invention also permits a machine-accessible medium containing instructions, which when executed by a machine, to cause the machine to perform operations for realizing the disclosed functionality of the invention. The invention disclosed herein is realized through use of appropriate equipment and enabling logic optionally reduced to code and/or hardware, which operate to control a database application via message requests (e.g. email, SMS messaging, or Instant Messaging) and an intelligent message processing system.

With reference to the drawings, there is shown and described a datasource interaction and operation method and system for interacting with a datasource in accordance with exemplary embodiments of the present invention. Unlike known systems, which can only authenticate based on the address of the user (email address, cell phone address, instant messaging address), and are inherently subject to spoofing and other surreptitious means of an unauthorized user pretending to be sending messages from the address of an authorized user. The invention described herein provides additional factors of authentication which prevent the unauthorized user from surreptitiously gaining access. Taken together with other known identifiers, the invention establishes beyond reasonable doubt that the alleged user is in fact the actual user attempting to gain access and information.

The exemplary embodiments described herein generally operate via the email protocol (common protocols include SMTP and IMAP), SMS mobile device protocol, or the Instant Messaging protocol. As is generally known in the art, the above protocols are secure specifications that allows users to communicate via electronic mail messages with authentication of who each user is and optional encryption of the message contents. It will be further understood that secure messaging protocols are only one exemplary type of electronic messaging protocol being used in connection with the present invention. Those of skill in the art will recognize that any electronic communication technology now known or hereafter developed may be used in connection with the exemplary embodiments of the invention described herein.

A method and system in accordance with the invention of using messages to send challenge-response questions to provide for multi-factor authentication before a user is granted access to an information source (database, database application, software application, or web-based information service) preferably includes the following sequence: transmitting an email, SMS messaging, or Instant Messaging message to a pre-defined email, SMS messaging, or Instant Messaging address; receiving the transmitted message by a receiving mail server; routing the email, SMS messaging, or Instant Messaging message to an application server; formatting a reply email, SMS messaging, or Instant Messaging message to the user containing a challenge question with optionally enumerated responses such that each individual item in the reply email, SMS messaging, or Instant Messaging message has a unique one character identifier next to it and that the sequence of the correct choice mixed in among incorrect but plausible choices is random from one message instance to the next; transmitting the reply email, SMS messaging, or Instant Messaging message to the user; the user replying to said email, SMS messaging, or Instant Messaging challenge question with either one of the choices or with the enumerated identifier corresponding to said; receiving and parsing the reply email, SMS messaging, or Instant Messaging comparing the response with the correct choice and the enumerated identifier of the correct choice; verifying that the time from when the challenge question message was sent until the reply message is received is within the preset timeout time period; formatting a new reply email, SMS messaging, or Instant Messaging message with either another challenge question or a menu of options related to gaining information or performing a function in the datasource of interest to the user or a message stating that access has been denied; transmitting the reply email, SMS messaging, or Instant Messaging message to the user.

This invention provides a mechanism for interactive (retrieve, update, and insert information) access to a datasource (database, database application, software application, or web-based information service) through the firewall and using embedded security authorization and optional data encryption. Originally used for banking functions from a cell phone, the invention can be used with a datasource and messaging protocol of any kind. The method of interaction relies on email, SMS (simple messaging service, known as “text messaging” on a mobile phone), or Instant Messaging, turning messaging into a multi-factor authenticated connection between user with messaging client and a datasource. Whether properly viewed as devices, methods, or systems, the disclosed invention also permits a machine-accessible medium containing instructions, which when executed by a machine, to cause the machine to perform operations for realizing the disclosed functionality of the invention. The invention disclosed herein is realized through use of appropriate equipment and enabling logic optionally reduced to code and/or hardware, which operate to control a database application via email requests and an intelligent email processing engine.

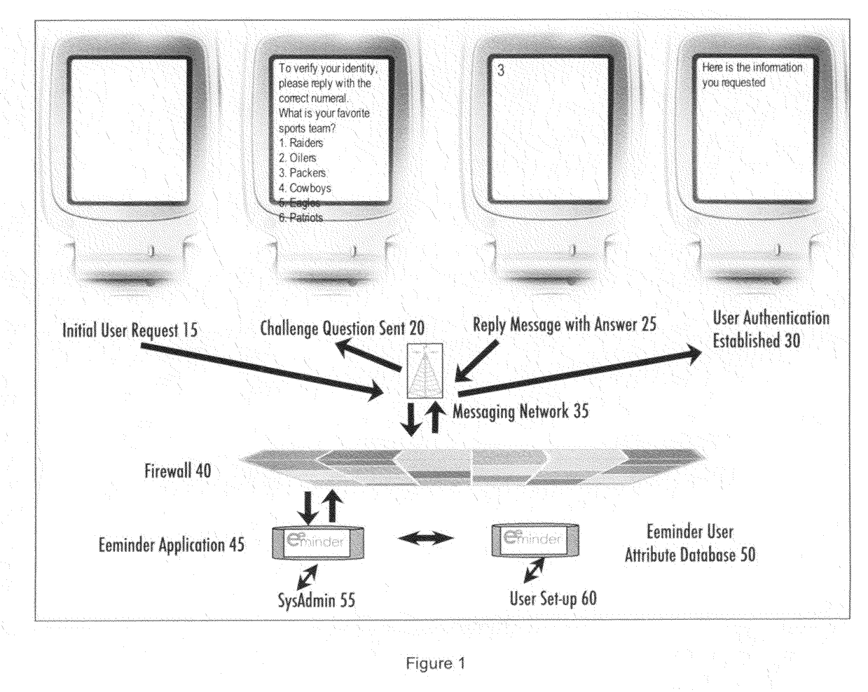

With reference to FIG. 1, the authentication system 10 preferably includes one or more server and database systems in communication with one another and capable of communicating with the devices of a plurality of users. In an exemplary embodiment, as shown in FIG. 1, messaging system 10 includes a messaging network system 15 which is communicatively connected to respective application server system 45, which includes a messaging formatting and routing application, an installation/configuration application, and function-specific scripts and routines, which are computer programs. The application server 45 is communicatively connected to the datasource(s) 50. The authentication system commences operation upon receipt of an initial request from an alleged user 15. The system analyzes the address of the message 15, matches it to a user in the database 50, and picks a challenge question for the user at random from all available questions established for that user. It picks random incorrect answers for the chose question which are of the same nature as the correct answer. It formats an outgoing message 20 to the alleged user with a question and randomized answers each with an identifier. The alleged user replies to the challenge message 20 with a response option 25 corresponding to the choice that the alleged user believes is correct. The authentication system analyzes the received reply message and compares the response option to the correct answer for the question it just sent. If a match is made then the authentication system formats and sends a new message to the user to initiate the session of access to information and functions that the user desires. Secure http (internet protocol) connections are used for user to set up their own challenge questions and correct answers and for the system administrative functions to maintain the same information. It should be noted that although the exemplary embodiments described herein describe use of separate servers and databases for performing the various functions of the messaging system 10, other embodiments could be implemented by storing the software or programming that operates the described functions on a single server or any combination of multiple servers as a matter of design choice so long as the functionality described herein is performed. Although not depicted in the figures, the server systems and applications 45 and 50 generally include such art recognized components as are ordinarily found in server systems, including but not limited to processors, RAM, ROM, clocks, hardware drivers, associated storage, and the like. One skilled in the art will recognize, however, that because multiple users may be accessing such servers at any given time it is preferable to utilize multiple servers and databases, which may be used separately or in tandem to support the systems traffic and processing, such as, by way of non-limiting example, a round-robin configuration utilizing multiple server systems.

Moreover, as will become evident from the following description and associated FIGS., users are in communication with the authentication system 10 via global communication networks 35, such as for example, Internet, cellular, satellite or other wireless communication network. One skilled in the art will also recognize that network 35 may also include a non-wireless component, such as, for example, the Public Switched Telephone Network (PSTN), cable or fiber optic networks. As such, it should be recognized that although the user's messaging device is itself in communication with some portion of network 35, network 35 may be comprised of any number of different types of communication devices enabling the transmission of data. It will also become apparent, that the various system components of the authentication system 10 are communicatively coupled to each of the other via a communication network such as local or wide area network (LAN or WAN).

Generally speaking, the authentication system 10 communicates with the users' messaging devices over a data communication connection 35 to permit the transmission of data. Adapting server systems such as those described herein to communicate with one or more wireless devices is well known to those of skill in the art. If the messaging medium is email, then the messaging network 35 is an email server network. If the messaging medium is SMS messaging, then the messaging network 35 is the carrier SMS network and gateway. If the messaging medium is Instant Messaging, then the messaging network 35 is the instant messaging routing server hosted by the instant messaging medium (e.g. America Online™, Yahoo!™, or others)

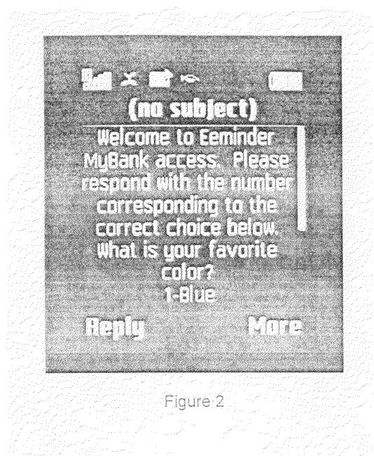

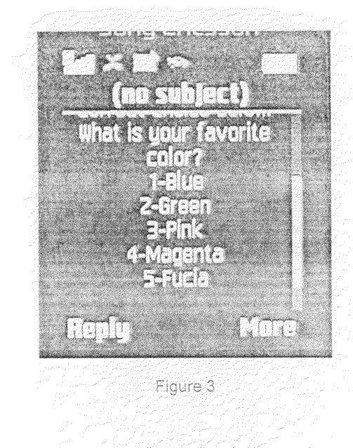

With reference to FIG. 2 and FIG. 3, the alleged user is sent a challenge question when attempting to initiate a session.

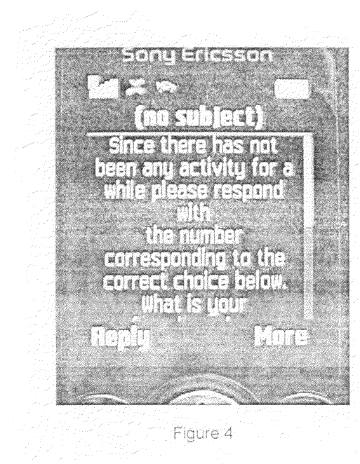

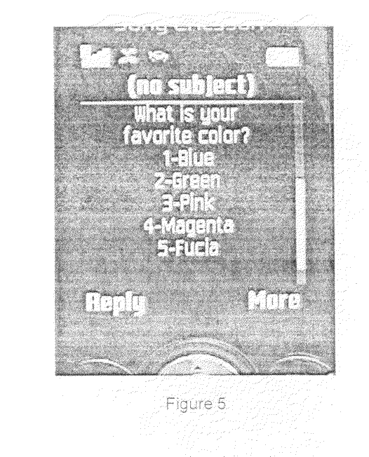

With reference to FIG. 4 and FIG. 5, since a period of time in excess fo the allowed time-out period has elapsed, a new challenge question is sent to the alleged user.

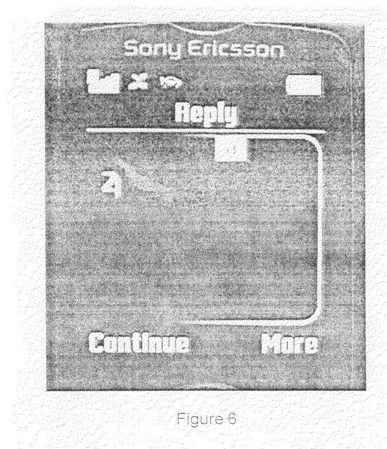

With reference to FIG. 6, a user can reply to the challenge question by typing only one keystroke corresponding to the enumerated answer chosen.

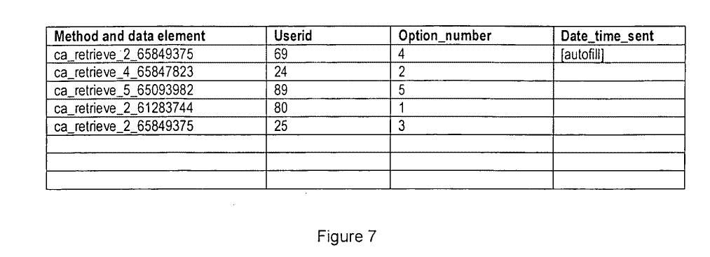

With reference to FIG. 7, the application server works in conjunction with the database server to randomly choose a question and then randomly choose incorrect but appropriate answers which then are randomized in order in the outgoing challenge question message. The database server stores the message information linked to the account holder (in the exemplary embodiment in which the authentication is used to access banking information) so that the correct choice can be matched in the user's reply message. The invention also provides for each challenge message sent to use the same enumerated identifiers e.g. 1, 2, 3 over and over with the application server being able to discern the correct response for each challenge question message sent.

Although a preferred embodiment of the invention (currently marketed as the “Eeminder” system available at www.eeminder.com) has been described herein, it is recognized that modifications and variations will occur to those skilled in the art which fall within the spirit of the invention and intended scope of the appended claims.

1. A method and system of using challenge and response questions in electronic messaging to provide authentication that an alleged user attempting to access an information source is in fact the authorized user.

2. The method of claim 1, wherein the challenge questions are presented as multiple choice questions.

3. The method of claim 1, wherein the challenge questions present enumerated multiple choice answers such that the alleged user only has to reply with the proper enumerated identifiere to answer the challenge question.

4. The method of claim 1, wherein the electronic messaging is electronic mail (“email”).

5. The method of claim 1, wherein the electronic messaging is SMS (short message service).

6. The method of claim 1, wherein the electronic messaging is MMS (multi-media messaging service).

7. The method of claim 1, wherein the electronic messaging is Instant Messaging.

8. A method and system of using messages to send challenge-response questions to provide for multi-factor authentication before a user is granted access to an information source (database, database application, software application, or web-based information service), the method comprising: transmitting an SMS message to a pre-defined SMS messaging address; receiving the transmitted message by a receiving messaging server; routing the SMS message to an application server; formatting a reply SMS message to the user containing a challenge question with optionally enumerated responses such that each individual item in the reply SMS message has a unique one character identifier next to it and that the sequence of the correct choice mixed in among incorrect but plausible choices is random from one message instance to the next; transmitting the reply SMS message to the user; the user replying to said SMS message challenge question with either one of the choices or with the enumerated identifier corresponding to said question; receiving and parsing the reply SMS message comparing the response with the correct choice and the enumerated identifier of the correct choice; verifying that the time from when the challenge question message was sent until the reply message is received is within the preset timeout time period; formatting a new reply SMS message with either another challenge question or a menu of options related to gaining information or performing a function in the datasource of interest to the user or a message stating that access has been denied; transmitting the reply SMS message to the user.

9. The method of claim 8 wherein the message protocol is MMS (multi-media messaging service) and providing for operation by: transmitting an MMS message to a pre-defined MMS messaging address; receiving the transmitted message by a receiving messaging server; routing the MMS message to an application server; formatting a reply MMS message to the user containing a challenge question with optionally enumerated responses such that each individual item in the reply MMS message has a unique one character identifier next to it and that the sequence of the correct choice mixed in among incorrect but plausible choices is random from one message instance to the next; transmitting the reply MMS message to the user; the user replying to said MMS message challenge question with either one of the choices or with the enumerated identifier corresponding to said question; receiving and parsing the reply MMS message comparing the response with the correct choice and the enumerated identifier of the correct choice; verifying that the time from when the challenge question message was sent until the reply message is received is within the preset timeout time period; formatting a new reply MMS message with either another challenge question or a menu of options related to gaining information or performing a function in the datasource of interest to the user or a message stating that access has been denied; transmitting the reply MMS message to the user.

10. The method of claim 8 wherein the message protocol is email and providing for operation by: transmitting an email message to a pre-defined email messaging address; receiving the transmitted message by a receiving messaging server; routing the email message to an application server; formatting a reply email message to the user containing a challenge question with optionally enumerated responses such that each individual item in the reply email message has a unique one character identifier next to it and that the sequence of the correct choice mixed in among incorrect but plausible choices is random from one message instance to the next; transmitting the reply email message to the user; the user replying to said email message challenge question with either one of the choices or with the enumerated identifier corresponding to said question; receiving and parsing the reply email message comparing the response with the correct choice and the enumerated identifier of the correct choice; verifying that the time from when the challenge question message was sent until the reply message is received is within the preset timeout time period; formatting a new reply email message with either another challenge question or a menu of options related to gaining information or performing a function in the datasource of interest to the user or a message stating that access has been denied; transmitting the reply email message to the user.

11. The method of claim 8 wherein the message protocol is instant messaging and providing for operation by: transmitting an instant messaging message to a pre-defined instant messaging messaging address; receiving the transmitted message by a receiving messaging server; routing the instant messaging message to an application server; formatting a reply instant messaging message to the user containing a challenge question with optionally enumerated responses such that each individual item in the reply instant messaging message has a unique one character identifier next to it and that the sequence of the correct choice mixed in among incorrect but plausible choices is random from one message instance to the next; transmitting the reply instant messaging message to the user; the user replying to said instant messaging message challenge question with either one of the choices or with the enumerated identifier corresponding to said question; receiving and parsing the reply instant messaging message comparing the response with the correct choice and the enumerated identifier of the correct choice; verifying that the time from when the challenge question message was sent until the reply message is received is within the preset timeout time period; formatting a new reply instant messaging message with either another challenge question or a menu of options related to gaining information or performing a function in the datasource of interest to the user or a message stating that access has been denied; transmitting the reply instant messaging message to the user.
